(19) United States
(12) Patent Application Publication
(10) Pub. No.: US 2006/0066378 A1
(43) Pub. Date: Mar. 30, 2006

(54) Semiconductor integrated circuit

(76) Inventor: Tadahiro Shimizu, Kyoto-shi (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/233,173

(22) Filed: Sep. 23, 2005

(30) Foreign Application Priority Data
Sep. 24, 2004 (JP) P.2004-276867

(51) Int. Cl. G06F 1/04

(52) U.S. Cl. 327/295

(57) ABSTRACT

To provide a semiconductor integrated circuit capable of adjusting the skew between gated circuits at a small number of man-hours and with low power consumption. The output terminal of each of gated elements is coupled with the input terminal of at least one circuit element. A delay element is inserted between each of the gated elements and each of the circuit elements to reduce the skew among the corresponding circuits. In this configuration, where an enable signal is supplied to the gate element and no signal is propagated to the circuit following the gated element in a gated circuit, power consumption can be reduced without the delay element.

### BACKGROUND OF THE INVENTION

1. Field of the Invention

This invention relates to a method for designing a clock supply controlling system and a clock supplying circuit system in gated clock designing for controlling the conduction/interruption of a clock signal by a clock gating signal.

2. Description of the Related Art

Recently, the frequency of clocks supplied to an LSI circuit and others has been dramatically improved. Correspondingly, an increase in power consumption of the circuit has become a serious problem. Concretely, it is problematic that the increase in the power consumption generates heat exceeding the heat dissipating limit of a package of the LSI circuit, and considerably shortens the battery life in a battery driving system.

Now it is assumed that the source of power consumption in an LSI chip is classified in sections of a data transfer system, clock system, input/output interface system, a function module, etc. In the case, among these sections,

the section giving greater power consumption is generally the clock system which operates at all times. Therefore in order to reduce the reduction in the power consumption in the LSI chip, it is the most efficient to implement low power consumption in the clock system.

A previously known most efficient method for reducing power consumption is a designing method called “gated clock”. This method makes it possible to design a clock supplying circuit capable of controlling the clock propagation so as to supply a clock signal to the corresponding register for only the period during which data transfer is necessary between registers.

On the other hand, in a clock-synchronized semiconductor integrated circuit, if the delayed time difference (hereinafter referred to as “skew”) of the clock signal between flip-flops (FFs) supplied with the clock signal is large, the semiconductor integrated circuit suffers from the adverse affect such as its non-operation or malfunction.

Thus, in a conventional gated clock circuit, proposed are method of reducing the skew between the gated clock circuits, such as inserting a delay element before gated, or individually setting the driving capability of the gated element or number of divisions (see JP-A-2001-22816).

However in the above method of inserting the delay element before gated, because the delay element is located before a gated element, the delay element is always driven, thereby consuming power.

Further, the above method of individually setting the driving capability of the gated element described in Patent Reference 1 requires a gated circuit dividing step of selecting the driving capability of a cell according to the total load capacity of each gated circuit and allotting the number of divisions of the gated circuit and the cell driving capability so that delayed values are uniform, thus requiring a large number of man-hours.

### SUMMARY OF THE INVENTION

In view of the above circumstance, an object of this invention is to provide a semiconductor integrated circuit capable of adjusting the skew between gated circuits at a small number of man-hours and with low power consumption.

In order to solve the above problem, the semiconductor integrated circuit according to this invention is

characterized by comprising: a clock generator for generating a clock signal; a plurality of clock wirings for supplying the clock signal created by the clock generator; at least one clock gating circuit provided so as to correspond to at least a part of the plurality of clock wirings for determining whether or not the clock signal is outputted on the basis of a clock gating signal; and at least one delay adjusting circuit provided so as to correspond to at least a part of the plurality of clock wirings for executing delay adjustment for the clock signal outputted from the clock gating circuit.

By adopting the configuration described above, the semiconductor integrated circuit according to this invention can stop the delay adjusting circuit at the rear stage of the clock gating circuit in clock gating so that it easily reduce the skew and reduce power consumption without increasing the number of designing man-hours.

### BRIEF DESCRIPTION OF THE DRAWINGS

FIG. 1 is an overall layout view of the semiconductor integrated circuit according to this invention.

FIG. 2 is a view showing the detailed layout of a clock supplying block.

### DESCRIPTION OF THE PREFERRED EMBODIMENTS

Now referring to the drawing, an explanation will be given of an embodiment of this invention.

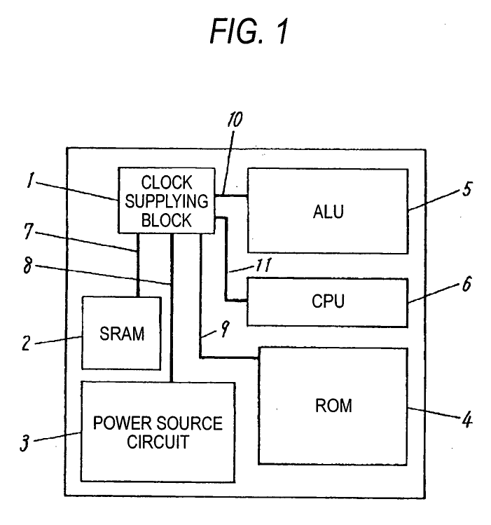

FIG. 1 is an overall layout view of the semiconductor integrated circuit according to an embodiment of this invention. The semiconductor integrated circuit is laid out in a plurality of blocks.

FIG. 1 is a layout view of the semiconductor integrated circuit. The semiconductor integrated circuit is constructed of various blocks. A clock supplying block 1 internally includes a clock generator to generate a clock signal and has a function of gating the clock signal. Blocks 2 to 6 are blocks which operate in response to clocks supplied from the clock supplying block 1. Now, for example, block 2 is a SRAM; block 3 is a power source circuit; block 4 is an ROM; block 5 is an ALU (Arithmetic Logic Unit); and block 6 is a CPU. The clock supply from the clock supplying block 1 is propagated to the block 2 through a clock wiring 7; to the block 3 through a clock wiring 8; to the block 4 through a clock wiring 9; and to the clock 5 through a clock wiring 10. However if the clock supplying bock 1 supplies the clock signals in phase to all the clock wirings, the respective clock wirings have different wiring lengths and use different wiring layers according to the blocks so that some skews are generated. In order to obviate such an inconvenience, the clock supplying block 1 must perform delay adjustment to supply the clock signal with no skew to the respective blocks.

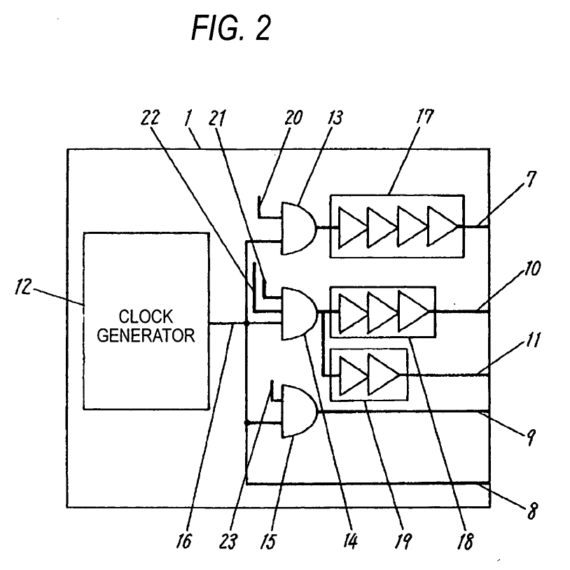

FIG. 2 is a view showing the detailed layout of the clock supplying block 1. In FIG. 2, like reference symbols refer to like constituent elements in FIG. 1.

The clock generator 12 generates the clock signal to be supplied to a main clock wiring 16. The main clock wiring 12 is branched into the respective clock wirings 7 to 11 so that the clock signal is eventually supplied to the blocks 2 to 6 in FIG. 1.

A gated element 13 is an AND circuit having inputs of the clock signal via the main clock wiring 16 and a clock gating signal 20. If the clock gating signal 20 is at “H”, the clock signal to be inputted is outputted as it is. The clock signal outputted from the gated element 13 is supplied to the clock wiring 7 through a delay element 17. If the clock gating signal 20 is “L”, the clock signal is not outputted by gating.

A gated element 14 is a three-input AND circuit having inputs of the clock signal via the main clock wiring 16 and clock gating signals 21, 22. If both the clock gating signals 21, 22 are at “H”, the clock signal to be inputted is outputted as it is. The clock signal outputted from the gated element 14 is branched so that it is supplied to the clock wiring 10 through a delay element 18 and supplied to the clock wiring 11 through a delay element 19. If either one of the clock gating signals 21, 22 is at “L”, the clock signal is not outputted by gating.

A gated element 15 is an AND circuit having inputs of the clock signal via the main clock wiring 16 and a clock gating signal 23. If the clock gating signal is at “H”, the clock signal to be inputted is outputted as it is. The clock signal outputted from the gated element 15 is supplied to the clock wiring 9 not via the delay element. If the clock gating signal 23 is at “L”, the clock signal is not outputted by gating.

Further, the clock wiring 8 is connected to the main clock wiring 16 not via the gated element and delay element.

Now, whether or not the delay element should be inserted and if inserted, its number of steps are determined in designing so as to eliminate the skew with respect to the clock supply to the respective blocks. In this embodiment, the clock wirings 7, 10 have a relatively shorter clock wiring length so that the delay element has a larger number of steps to be inserted. The clock wirings 8, 9 have a relatively longer clock wiring length so that the delay element is not inserted.

It is of course that the number of steps inserted in the delay element is not determined on the basis of only the wiring length, but determined on the basis of the various factors such as the clock latency, driving load capacity, wiring layer, etc. in each block.

Now it should be noted that the clock signal gated by the gated element is supplied to the respective blocks except the block of the power source circuit 3. Specifically, during non-operation of the semiconductor integrated circuit, by setting the clock gating signal at “L”, the clock supply is stopped to reduce the power consumption. The clock signal with what block is supplied should be gated is designed according to the intended specification of the semiconductor integrated circuit.

Now it should be noted that this invention is different from the prior art in that the delay adjustment is carried out by the provision of the delay element at the rear stage of the gated element. In accordance with such a configuration, in gating the clock signal, the clock signal supplied to the delay element provided for delay adjustment (for eliminating the skew) is also stopped so that the effect of reduction in the power consumption can be obtained.

In designing, after each of the blocks has been first arranged, the clock wirings are installed, and the delay adjustment is carried out. In this case, since the delay adjustment is only carried out at the rear stage of the gate element, it can be realized in a small number of man-hours.

Additionally, it is desirable that the gated element is supplied with the clock signal from the clock generator 12 not via the delay element. But it is possible that a buffer (having the construction equivalent to the delay element) is arranged at the rear stage of the clock generator 12 for the purpose of amplifying the clock signal and others. As long as a part of the delay elements for delay adjustment is arranged at the rear stage of the gate elements, the effect of low power consumption can be correspondingly obtained. But it is preferable that all the delay elements for delay adjustment are located at the rear stage of the gated elements because the power consumption can be reduced more greatly and the layout can be simplified.

Additionally, it is preferable that as in this embodiment, the delay elements for delay adjustment are arranged within the clock supplying block. This is because the skew after the delay elements have been inserted can be analyzed within the clock supplying block, and where the number of inserted steps in each of the delay elements is changed on the basis of the skew analysis, without changing the blocks other than the clock supplying block, the layout can be changed without the clock supplying block. But the delay elements may be arranged in the wiring area of the clock wirings (area outside the blocks supplied with the clock signal).

Further, in this embodiment, a single clock wiring extending from the clock supplying block propagates the clock signal to a single block. But the single clock wiring may be branched outside the clock supplying block so as to propagate the clock signal to a plurality of blocks.

This invention, which can realize a semiconductor integrated circuit with low power consumption, can be applied to various fields of electronic devices.

What is claimed is:

1. A semiconductor integrated circuit, comprising:
a clock generator, generating a clock signal;
a plurality of clock wirings, supplying the clock signal created by the clock generator;
at least one clock gating circuit, provided so as to correspond to at least a part of the plurality of clock wirings for determining whether or not the clock signal is outputted on the basis of a clock gating signal; and
at least one delay adjusting circuit, provided so as to correspond to at least a part of the plurality of clock wirings for executing delay adjustment for the clock signal outputted from the clock gating circuit.

2. The semiconductor integrated circuit according to claim 1, wherein at least one of the at least one clock gating circuit has a single clock gating terminal, and determines whether or not the clock signal should be outputted according to the signal inputted to the single clock gating terminal.

3. The semiconductor integrated circuit according to claim 1, wherein at least one of the at least one clock gating circuit has a plurality of clock gating input terminals, and determines whether or not the clock signal should be outputted according to a combination of signals inputted to the plurality of clock gating terminals.

4. The semiconductor integrated circuit according to claim 1, wherein the semiconductor integrated circuit includes
a clock supplying block; and
a plurality of clock supplied blocks which are supplied with the clock signal through the plurality of clock wirings from the clock supplying block, and the clock generator is arranged within the clock supplying block.

5. The semiconductor integrated circuit according to claim 1, wherein the at least one clock gating circuit and the at least one delay adjusting circuit are arranged within the clock supplying block.

6. The semiconductor integrated circuit according to claim 1, wherein the at least one of the at least one clock gating circuit outputs the clock signal to the plurality of clock supplied blocks.

7. The semiconductor integrated circuit according to claim 1, wherein at least one of the plurality of clock supplied blocks is a memory block.

8. The semiconductor integrated circuit according to claim 1, wherein at least one of the plurality of clock supplied blocks is a CPU.

9. The semiconductor integrated circuit according to claim 1, wherein the at least one clock gating circuit is supplied with the clock signal from the clock generator through only the plurality of clock wirings.
